(19) United States
(12) Patent Application Publication
(10) Pub. No.: US 2026/0143190 A1
(43) Pub. Date: May 21, 2026

(54) ADJUSTMENT METHOD BASED ON LIVE STREAMING PICTURE, AND RELATED APPARATUS

(71) Applicant: Tencent Technology (Shenzhen) Company Limited, Shenzhen (CN)

(72) Inventor: Shangzhen ZHENG, Shenzhen (CN)

(21) Appl. No.: 19/447,813

(22) Filed: Jan. 13, 2026

Related U.S. Application Data
(63) Continuation of application No. PCT/CN2024/115090, filed on Aug. 28, 2024.

(30) Foreign Application Priority Data
Oct. 31, 2023 (CN) 202311438267.4

(51) Int. Cl. H04N 21/4402; H04N 21/2187; H04N 21/44

(52) U.S. Cl. CPC H04N 21/440245; H04N 21/2187; H04N 21/44008

(57) ABSTRACT

This application discloses a method for adjusting a live streaming picture performed by a computer device. The method includes: performing object detection on picture content of a first live streaming picture to obtain candidate detection boxes respectively corresponding to a plurality of preset objects in the first live streaming picture; segmenting a target object in a target detection box from the first live streaming picture for the target detection box in the plurality of candidate detection boxes to obtain a second live streaming picture and a first object image of the target object; adjusting the first object image according to a preset adjustment strategy for highlighting one or more of the plurality of preset objects to obtain a second object image; and fusing the second object image and the second live streaming picture to obtain a third live streaming picture.

### CROSS-REFERENCE TO RELATED APPLICATIONS

This application is a continuation application of PCT Patent Application No. PCT/CN2024/115090, entitled “ADJUSTMENT METHOD BASED ON LIVE STREAMING PICTURE, AND RELATED APPARATUS” filed on Aug. 28, 2024, which claims priority to Chinese Patent Application No. 202311438267.4, entitled “ADJUSTMENT METHOD BASED ON LIVE STREAMING PICTURE, AND RELATED APPARATUS” filed with the China National Intellectual Property Administration on Oct. 31, 2023, all of which are incorporated herein by reference in their entirety.

### FIELD OF THE TECHNOLOGY

This application relates to the field of computer technologies, and in particular, to an adjustment technology of live streaming pictures.

### BACKGROUND OF THE DISCLOSURE

With the rapid development of live streaming technologies, the live streaming technologies are spread in daily life or work. Live streamer users may use live streaming software on their terminals to shoot live streaming pictures, and transmit the live streaming pictures to a server. The server subsequently transmits the live streaming pictures to viewer terminals, allowing viewer users to view the live streaming pictures.

In a related technology, a method for adjusting a live streaming picture includes: extracting a contour image of a live streamer from the live streaming picture, and beautifying the contour image of the live streamer, so as to improve the live streamer's appearance. Alternatively, live streaming backgrounds other than the live streamer in the live streaming picture are replaced, so as to create more engaging live streaming backgrounds.

However, the foregoing method is only intended to beautify main objects such as the live streamer in the live streaming picture or replace regions such as backgrounds in the live streaming picture, and preset objects such as the live streamer or objects in the live streaming picture cannot be highlighted. Consequently, viewer users cannot be attracted to focus on the preset objects in the live streaming picture, thereby undermining the live streaming effect.

### SUMMARY

To solve the foregoing technical problem, this application provides an adjustment method based on a live streaming picture, and a related apparatus. By detection, segmentation and adjustment of target objects in a live streaming picture and re-fusion of the target objects into the live streaming picture, this application can achieve the display effect of highlighting preset objects in the live streaming picture without changing the size of the live streaming picture, so as to attract viewer users to focus on the preset objects in the live streaming picture, thereby improving the live streaming effect.

Embodiments of this application disclose the following technical solutions.

According to one aspect, an embodiment of this application provides a method for adjusting a live streaming picture, the method being performed by a computer device, and the method comprising:
performing object detection on picture content of a first live streaming picture to obtain candidate detection boxes respectively corresponding to a plurality of preset objects in the first live streaming picture;
segmenting a target object in a target detection box from the first live streaming picture to obtain a second live streaming picture and a first object image of the target object, the second live streaming picture referring to a live streaming picture excluding the first object image of the target object in the first live streaming picture;
adjusting the first object image according to a preset adjustment strategy to obtain a second object image; and
performing image fusion on the second object image and the second live streaming picture to obtain a third live streaming picture including the second object image.

According to another aspect, an embodiment of this application provides a computer device, the computer device including a processor and a memory,
the memory being configured to store a computer program and transmit the computer program to the processor; and
the processor being configured to perform the method according to any one of the foregoing aspects based on an instruction in the computer program.

According to another aspect, an embodiment of this application provides a non-transitory computer-readable storage medium storing a computer program, and the computer program, when run by a processor of a computer device, causing the computer device to perform the method according to any one of the foregoing aspects.

It can be seen from the foregoing technical solution that first, object detection is performed on the picture content of the first live streaming picture, so as to obtain the plurality of candidate detection boxes corresponding to the plurality of preset objects in the first live streaming picture; and the target object in the target detection box is segmented from the first live streaming picture for the target detection box in the plurality of candidate detection boxes, so as to obtain the second live streaming picture and the first object image of the target object. In this operation, by object detection and image segmentation, the first live streaming picture can be accurately segmented into the first object image of the to-be-adjusted target object and the to-be-fused second live streaming picture. Then, the first object image is adjusted according to the preset adjustment strategy for highlighting one or more of the plurality of preset objects, so as to obtain the second object image; and the second object image and the second live streaming picture are fused, so as to obtain the third live streaming picture. In this operation, the first object image of the target object is changed into the second object image by image adjustment and image fusion based on the preset adjustment strategy, and the second object image is fused to the second live streaming picture, so as to obtain the third live streaming picture, so that the third live streaming picture can highlight one or more of the plurality of preset objects. Based on this, by detection, segmentation and adjustment of the target objects in the live streaming picture and re-fusion of the target objects into the live streaming picture, the method can achieve the display effect of highlighting the preset objects in the live streaming picture without changing the size of the live streaming picture, so as to attract viewer users to focus on the preset objects in the live streaming picture, thereby improving the live streaming effect.

### BRIEF DESCRIPTION OF THE DRAWINGS

To describe the technical solutions in embodiments of this application or in the related art more clearly, the following briefly introduces the accompanying drawings required for describing the embodiments or the related art. Apparently, the accompanying drawings in the following description show only some embodiments of this application. Those of ordinary skill in the art can also obtain other accompanying drawings according to these accompanying drawings without any creative work.

FIG. 1 is a schematic diagram of a system architecture of an adjustment method based on a live streaming picture according to an embodiment of this application.

FIG. 2 is a flowchart of an adjustment method based on a live streaming picture according to an embodiment of this application.

FIG. 3 is a schematic diagram of a plurality of candidate detection boxes corresponding to a plurality of preset objects in a first live streaming picture according to an embodiment of this application.

FIG. 4 is a schematic diagram of a target detection box in a plurality of candidate detection boxes in a first live streaming picture according to an embodiment of this application.

FIG. 5 is a schematic diagram of a second live streaming picture and a first object image of a target object according to an embodiment of this application.

FIG. 6 is a schematic diagram of adjusting a first object image of a target object to a second object image according to an embodiment of this application.

FIG. 7 is a schematic diagram of a third live streaming picture according to an embodiment of this application.

FIG. 8 is a diagram showing specific operations of an adjustment method based on a live streaming picture according to an embodiment of this application.

FIG. 9 is a schematic diagram of moving a first object image of a target object in a first live streaming picture to a second object image according to an embodiment of this application.

FIG. 10 is a schematic diagram of a second live streaming picture including a to-be-filled region according to an embodiment of this application.

FIG. 11 is a flowchart of determining a detection frequency according to an embodiment of this application.

FIG. 12 is a structural diagram of an adjustment apparatus based on a live streaming picture according to an embodiment of this application.

FIG. 13 is a structural diagram of a terminal according to an embodiment of this application.

FIG. 14 is a structural diagram of a server according to an embodiment of this application.

### DESCRIPTION OF EMBODIMENTS

The following describes the embodiments of this application with reference to the accompanying drawings.

At this stage, a method for adjusting a live streaming picture may be intended to extract a contour image of a live streamer from the live streaming picture, and beautify the contour image of the live streamer, so as to improve the live streamer's appearance. Alternatively, live streaming backgrounds other than the contour image of the live streamer in the live streaming picture are replaced, so as to create more engaging live streaming backgrounds.

However, it is found through research that the foregoing method is only intended to beautify main objects such as the live streamer in the live streaming picture or replace regions such as backgrounds in the live streaming picture, and preset objects such as the live streamer or objects in the live streaming picture cannot be highlighted. Consequently, viewer users cannot be attracted to focus on the preset objects in the live streaming picture, thereby undermining the live streaming effect.

An embodiment of this application provides an adjustment method based on a live streaming picture. By detection, segmentation and adjustment of target objects in a live streaming picture and re-fusion of the target objects into the live streaming picture, the method can achieve the display effect of highlighting preset objects in the live streaming picture without changing the size of the live streaming picture, so as to attract viewer users to focus on the preset objects in the live streaming picture, thereby improving the live streaming effect.

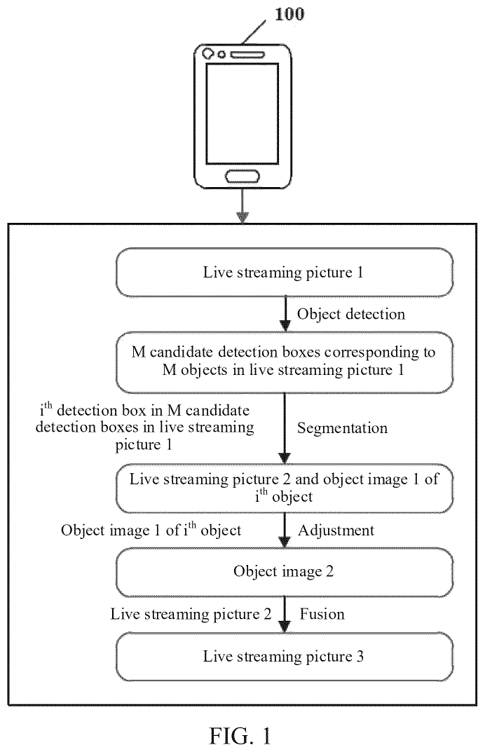

Next, a system architecture of the adjustment method based on a live streaming picture is introduced. Referring to FIG. 1, FIG. 1 is a schematic diagram of a system architecture of an adjustment method based on a live streaming picture according to an embodiment of this application. The system architecture includes a terminal 100. The terminal 100 is configured to perform the adjustment method based on a live streaming picture.

The terminal 100 performs object detection on picture content of a first live streaming picture, so as to obtain candidate detection boxes respectively corresponding to a plurality of preset objects in the first live streaming picture.

As an example, the first live streaming picture is a live streaming picture 1, a plurality of preset objects in the live streaming picture 1 include M objects, and M is a positive integer. Therefore, the terminal 100 may perform object detection on picture content of the live streaming picture 1, so as to obtain M candidate detection boxes corresponding to the M objects in the live streaming picture 1.

The terminal 100 segments a target object in a target detection box from the first live streaming picture according to the target detection box in the plurality of candidate detection boxes, so as to obtain a second live streaming picture and a first object image of the target object.

As an example, based on the foregoing example, a target detection box in the M candidate detection boxes is an i^{th} detection box, where i∈M. For the i^{th} detection box, the terminal 100 segments a target object in the i^{th} detection box from the live streaming picture 1 as an i^{th} object, so as to obtain a second live streaming picture as a live streaming picture 2 and a first object image of the i^{th} object as an object image 1, where the live streaming picture 2 refers to the live streaming picture 1 from which the object image 1 is segmented, and the live streaming picture 2 includes M−1 preset objects other than the i^{th} object in the M objects.

The terminal 100 adjusts the first object image according to a preset adjustment strategy, so as to obtain a second object image, the preset adjustment strategy being configured for highlighting one or more of the plurality of preset objects.

As an example, the preset adjustment strategy includes one or more of a size adjustment strategy and a position adjustment strategy. Based on the foregoing example, the terminal 100 adjusts the object image 1 according to one or more of the size adjustment strategy and the position adjustment strategy, so as to obtain a second object image as an object image 2.

The terminal 100 performs image fusion on the second object image and the second live streaming picture, so as to obtain a third live streaming picture.

As an example, based on the foregoing example, the object image 2 and the live streaming picture 2 are fused to obtain a third live streaming picture as a live streaming picture 3. The live streaming picture 3 includes M−1 preset objects and the i^{th} object represented by the object image 2 (the adjusted object image 1), and a total of M objects.

That is, by object detection and image segmentation, the first live streaming picture can be accurately segmented into a first object image of a to-be-adjusted target object and a to-be-fused second live streaming picture. The first object image of the target object is changed into the second object image by image adjustment and image fusion based on the preset adjustment strategy, and the second object image is fused to the second live streaming picture, so as to obtain the third live streaming picture, so that the third live streaming picture can highlight one or more of the plurality of preset objects. Based on this, by detection, segmentation and adjustment of the target objects in the live streaming picture and re-fusion of the target objects into the live streaming picture, the method can achieve the display effect of highlighting the preset objects in the live streaming picture without changing the size of the live streaming picture, so as to attract viewer users to focus on the preset objects in the live streaming picture, thereby improving the live streaming effect.

In this embodiment of this application, the computer device may be a server or a terminal. The method provided in this embodiment of this application may be independently performed by the terminal or the server, or may be cooperatively performed by the terminal and the server. The embodiment corresponding to FIG. 1 is introduced mainly by an example in which a terminal performs the method provided in this embodiment of this application.

In addition, when the method provided in this embodiment of this application is independently performed by the server, a performing method thereof is similar to that in the embodiment corresponding to FIG. 1, and the terminal is mainly changed to the server. Moreover, when the method provided in this embodiment of this application is cooperatively performed by the terminal and the server, operations that need to be embodied on a front-end interface may be performed by the terminal, and some operations that need to be calculated on a backend and do not need to be embodied on the front-end interface may be performed by the server.

The terminal may be a smartphone, a tablet computer, a notebook computer, a desktop computer, an intelligent voice interaction device, an on-board terminal, or an aircraft, but is not limited thereto. The server may be an independent physical server, a server cluster or a distributed system including a plurality of physical servers, or a cloud server providing a cloud computing service, but is not limited thereto. The terminal and the server may be directly or indirectly connected in a wired or wireless communication mode. This is not limited in this application. For example, the terminal and the server may be connected through a network. The network may be a wired or wireless network.

The method provided in this embodiment of this application relates to an artificial intelligence (AI) technology. The adjustment method based on a live streaming picture is automatically implemented based on the AI technology.

In addition, this embodiment of this application may be applied to various scenarios, including but not limited to a cloud technology, AI, intelligent transportation, audios and videos, and aided driving.

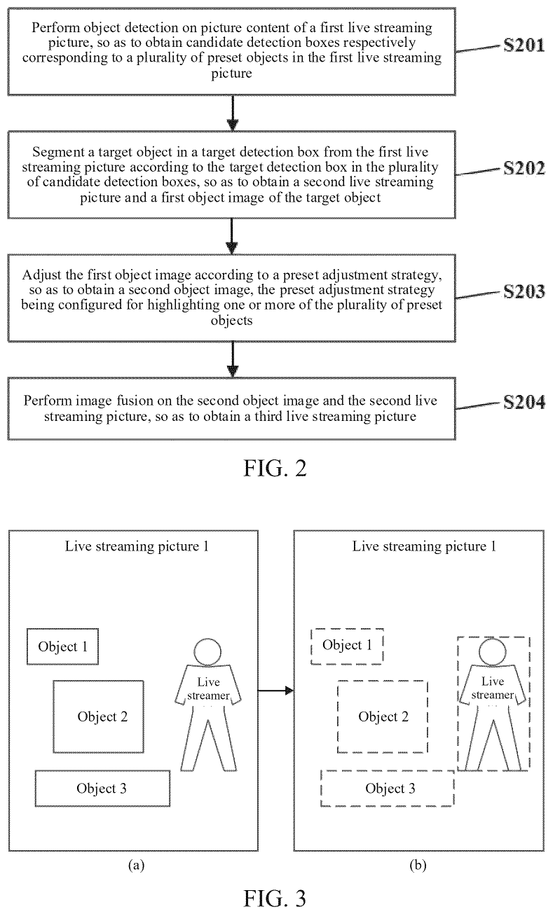

Next, the adjustment method based on a live streaming picture according to this embodiment of this application is introduced in detail with reference to the accompanying drawings by an example in which a terminal performs the method provided in this embodiment of this application. Referring to FIG. 2, FIG. 2 is a flowchart of an adjustment method based on a live streaming picture according to an embodiment of this application. The method includes:
S201: Perform object detection on picture content of a first live streaming picture, so as to obtain candidate detection boxes respectively corresponding to a plurality of preset objects in the first live streaming picture.

In a related technology, a contour image of a live streamer may be extracted from the live streaming picture, and the contour image of the live streamer is beautified, so as to improve the live streamer's appearance. Alternatively, live streaming backgrounds other than the contour image of the live streamer in the live streaming picture are replaced, so as to create more engaging live streaming backgrounds. However, it is found through research that the foregoing method is only intended to beautify main objects such as the live streamer in the live streaming picture or replace regions such as backgrounds in the live streaming picture, and preset objects such as the live streamer or objects in the live streaming picture cannot be highlighted. Consequently, viewer users cannot be attracted to focus on the preset objects in the live streaming picture, thereby undermining the live streaming effect.

Therefore, in this embodiment of this application, to highlight the preset objects in the live streaming picture, a plurality of preset objects in the live streaming picture need to be detected first, so that the preset objects can be highlighted in the live streaming picture subsequently. Based on this, a first live streaming picture is obtained, and object detection is performed on picture content of the first live streaming picture, so as to obtain a plurality of candidate detection boxes corresponding to a plurality of preset objects in the first live streaming picture. The preset object may be an object captured or presented in a live streaming process, for example, may be a live streamer or various objects.

In an actual application, S201 may perform object detection on the picture content of the first live streaming picture by an object detection algorithm, so as to obtain a plurality of candidate detection boxes corresponding to a plurality of preset objects in the first live streaming picture. The object detection algorithm may be a target detection algorithm, for example, a fast region-based convolutional neural network (Fast R-CNN) algorithm, and a specific implementation process of S201 is: performing feature extraction on the picture content of the first live streaming picture by the Fast R-CNN algorithm, so as to obtain image features of the first live streaming picture; performing object-based region extraction on picture content of the first live streaming picture according to the image features of the first live streaming picture, so as to obtain region images respectively corresponding to a plurality of preset objects in the first live streaming picture; performing object detection on a plurality of region images in the first live streaming picture, so as to obtain prediction detection boxes respectively corresponding to a plurality of preset objects in the first live streaming picture; and performing regression processing on the plurality of prediction detection boxes in the first live streaming picture, so as to obtain candidate detection boxes respectively corresponding to a plurality of preset objects in the first live streaming picture.

In S201, the first live streaming picture is processed by object detection, and candidate detection boxes of each preset object in the first live streaming picture can be accurately detected, thereby providing effective and accurate detection data for subsequently accurately segmenting the first live streaming picture into a first object image of a to-be-adjusted target object and a to-be-fused second live streaming picture.

As an example of S201, referring to FIG. 3, FIG. 3 is a schematic diagram of a plurality of candidate detection boxes corresponding to a plurality of preset objects in a first live streaming picture according to an embodiment of this application. FIG. 3(a) indicates that the first live streaming picture is a live streaming picture 1, and a plurality of preset objects in the live streaming picture 1 include four objects, that is, a live streamer, an object 1, an object 2, and an object 3. FIG. 3(b) indicates that the terminal may perform object detection on picture content of the live streaming picture 1 to obtain a candidate detection box corresponding to the live streamer in the live streaming picture 1 as a live streamer detection box, a candidate detection box corresponding to the object 1 as an object 1 detection box, a candidate detection box corresponding to the object 2 as an object 2 detection box, and a candidate detection box corresponding to the object 3 as an object 3 detection box, that is, four dashed boxes in FIG. 3(b).
S202: Segment a target object in a target detection box from the first live streaming picture according to the target detection box in the plurality of candidate detection boxes, so as to obtain a second live streaming picture and a first object image of the target object.

In this embodiment of this application, to highlight the preset objects such as the live streamer or the objects in the live streaming picture, after a plurality of preset objects such as the live streamer and the objects in the live streaming picture are detected, the target object further needs to be selected from a plurality of preset objects, and the target object is segmented from the live streaming picture, so that the preset objects can be highlighted in the live streaming picture by adjusting the target object subsequently.

Based on this, after the plurality of candidate detection boxes corresponding to a plurality of preset objects in the first live streaming picture are detected in S201, the target detection box further needs to be selected for the plurality of candidate detection boxes, and the target object in the target detection box is segmented from the first live streaming picture, so as to obtain the second live streaming picture and the first object image of the target object. The second live streaming picture refers to the first live streaming picture from which the first object image of the target object is segmented, that is, the second live streaming picture refers to another live streaming picture excluding the first object image of the target object in the first live streaming picture. Therefore, the second live streaming picture includes objects other than the target object in a plurality of preset objects.

In an actual application, S202 may determine a target detection box in the plurality of candidate detection boxes in response to a selection operation on the target detection box in the plurality of candidate detection boxes, or may determine the target detection box corresponding to the target object in the plurality of candidate detection boxes in response to detecting that the live streaming voice corresponding to the first live streaming picture includes the target object. The target object in the target detection box is segmented from the first live streaming picture according to the target detection box by an image segmentation algorithm, so as to obtain the second live streaming picture and the first object image of the target object. The image segmentation algorithm may be an instance segmentation algorithm, for example, a mask region-based convolutional neural network (Mask R-CNN) algorithm, and a specific implementation process of S202 is: adding a segmentation branch based on the Fast R-CNN algorithm to detect a contour of an object, and performing object-based contour detection according to the target detection box in the first live streaming picture and image features of the target detection box by the Mask R-CNN algorithm, so as to obtain a target contour image of the target object; performing image segmentation on the first live streaming picture according to the target contour image, so as to obtain a target object image of the target object; and performing image separation on the target object and the background region in the target object image, so as to obtain a first object image of the target object.

In S202, the first live streaming picture is processed by image segmentation, and the first live streaming picture can be accurately segmented into a first object image of a to-be-adjusted target object and a to-be-fused second live streaming picture, thereby providing targeted and accurate image data for highlighting the preset objects in the second live streaming picture subsequently by adjusting the target object.

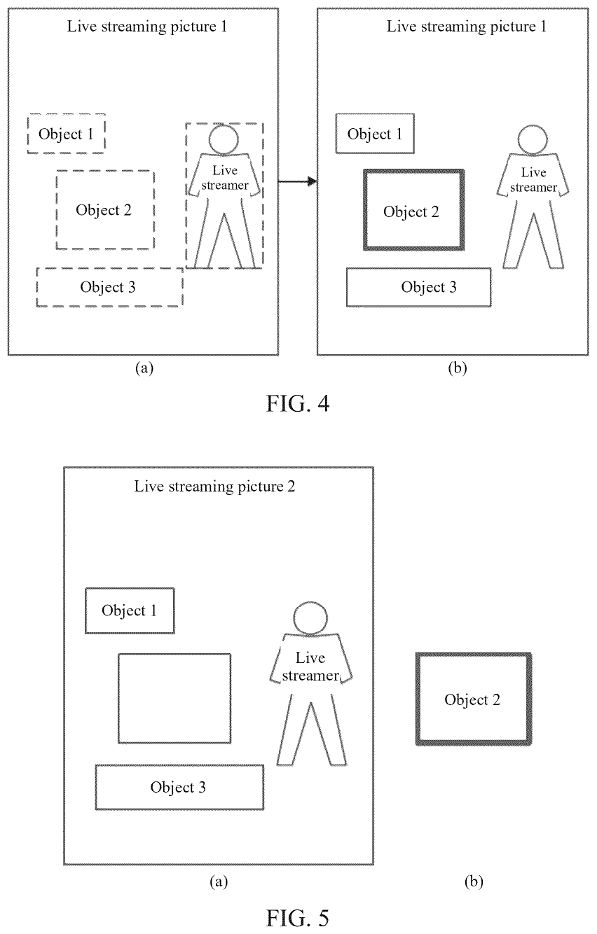

As an example of S202, based on the foregoing example of S201, referring to FIG. 4, FIG. 4 is a schematic diagram of a target detection box in a plurality of candidate detection boxes in a first live streaming picture according to an embodiment of this application. Based on FIG. 3, in response to a selection operation on the object 2 detection box in the live streamer detection box, the object 1 detection box, the object 2 detection box, and the object 3 detection box in the live streaming picture 1 shown in FIG. 4(a), the terminal determines the target detection box as the object 2 detection box, that is, the bold box in FIG. 4(b), in the live streamer detection box, the object 1 detection box, the object 2 detection box, and the object 3 detection box.

Referring to FIG. 5, FIG. 5 is a schematic diagram of a second live streaming picture and a first object image of a target object according to an embodiment of this application. Based on FIG. 4, the terminal segments the object 2 in the object 2 detection box from the live streaming picture 1, so as to obtain the second live streaming picture indicated in FIG. 5(a) as a live streaming picture 2 and the first object image of the target object indicated in FIG. 5(b) as an object 2 image 1 of the object 2, where the live streaming picture 2 refers to the live streaming picture 1 from which the object 2 image 1 is segmented, that is, the live streaming picture 2 refers to another live streaming picture other than the object 2 image 1 in the live streaming picture 1, and the live streaming picture 2 includes a live streamer, an object 1, and an object 3.
S203: Adjust the first object image according to a preset adjustment strategy, so as to obtain a second object image, the preset adjustment strategy being configured for highlighting one or more of the plurality of preset objects.

In this embodiment of this application, to highlight the preset objects such as the live streamer or objects in the live streaming picture, after the target object in a plurality of preset objects is segmented from the live streaming picture, the target object further needs to be adjusted based on a principle of highlighting one or more of the plurality of preset objects, so that the preset objects can be subsequently highlighted in the live streaming picture.

Based on this, after the first live streaming picture is segmented into the second live streaming picture and the first object image of the target object in S202, the first object image further needs to be adjusted according to the preset adjustment strategy for highlighting one or more of the plurality of preset objects, so as to obtain the adjusted first object image as the second object image. The preset adjustment strategy for highlighting one or more of the plurality of preset objects may be configured for highlighting the target object in a plurality of preset objects, or highlighting the preset objects other than the target object in a plurality of preset objects.

In S203, the first object image of the target object is processed by image adjustment based on a preset adjustment strategy, so that the first object image of the target object is accurately changed into the second object image. The second object image is fused to the second live streaming picture to highlight one or more of the plurality of preset objects, thereby providing accurate and effective image data for subsequently highlighting the preset objects in the second live streaming picture.

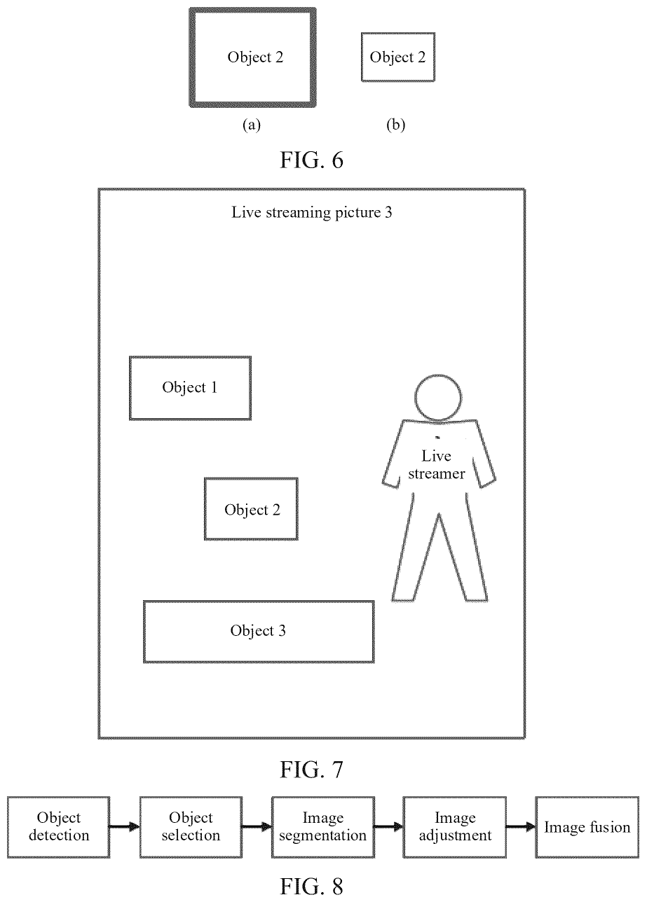

As an example of S203, based on the foregoing example of S203, referring to FIG. 6, FIG. 6 is a schematic diagram of adjusting a first object image of a target object in a first live streaming picture to a second object image according to an embodiment of this application. Based on FIG. 5, an object 2 image 1 indicated in FIG. 6(a) is adjusted according to a preset adjustment strategy for highlighting one or more of the plurality of preset objects, so as to obtain a second object image indicated in FIG. 6(b) as an object 2 image 2.
S204: Perform image fusion on the second object image and the second live streaming picture, so as to obtain a third live streaming picture.

In this embodiment of this application, to achieve the display effect of highlighting the preset objects in the live streaming picture, so as to attract viewer users to focus on the preset objects in the live streaming picture, after the target object is adjusted, the adjusted target object further needs to be re-fused to the live streaming picture, so as to highlight the preset objects such as the live streamer or objects in the live streaming picture. Based on this, after the first object image of the target object is adjusted to the second object image according to the preset adjustment strategy for highlighting one or more of the plurality of preset objects in S203, the second object image and the second live streaming picture further need to be fused, so as to obtain a third live streaming picture.

In S204, the second live streaming picture and the second object image are processed by image fusion, and the second object image obtained by changing the first object image of the target object is fused to the second live streaming picture, so as to obtain the third live streaming picture, so that the third live streaming picture can highlight one or more of the plurality of preset objects to achieve the display effect of highlighting the preset objects in the third live streaming picture, so as to attract viewer users to focus on the preset objects in the third live streaming picture, thereby improving the live streaming effect.

As an example of S204, based on S203, referring to FIG. 7, FIG. 7 is a schematic diagram of a third live streaming picture according to an embodiment of this application. Based on FIG. 5 and FIG. 6, the object 2 image 2 indicated in FIG. 6(b) and the live streaming picture 2 indicated in FIG. 5(a) are fused, so as to obtain the third live streaming picture indicated in FIG. 7 as a live streaming picture 3. The live streaming picture 3 includes a live streamer, an object 1, an object 3, and an object 2 represented by the object 2 image 2 (the adjusted object 2 image 1).

In conclusion, referring to FIG. 8, FIG. 8 is a diagram showing specific operations of an adjustment method based on a live streaming picture according to an embodiment of this application. The specific operations include: operation 1: object detection: perform object detection on the picture content of the first live streaming picture by an object detection algorithm, so as to obtain a plurality of candidate detection boxes corresponding to a plurality of preset objects in the first live streaming picture; operation 2: object selection: determine a target detection box in the plurality of candidate detection boxes in response to a selection operation on the target detection box in the plurality of candidate detection boxes; operation 3: image segmentation: segment a target object in the target detection box from the first live streaming picture according to the target detection box by an image segmentation algorithm, so as to obtain a second live streaming picture and a first object image of the target object; operation 4: image adjustment: adjust the first object image according to a preset adjustment strategy for highlighting one or more of the plurality of preset objects, so as to obtain a second object image; and operation 5: image fusion: perform image fusion on the second object image and the second live streaming picture, so as to obtain a third live streaming picture.

It can be seen from the foregoing technical solution that first, object detection is performed on the picture content of the first live streaming picture, so as to obtain the plurality of candidate detection boxes corresponding to the plurality of preset objects in the first live streaming picture; and the target object in the target detection box is segmented from the first live streaming picture for the target detection box in the plurality of candidate detection boxes, so as to obtain the second live streaming picture and the first object image of the target object. In this operation, by object detection and image segmentation, the first live streaming picture can be accurately segmented into the first object image of the to-be-adjusted target object and the to-be-fused second live streaming picture. Then, the first object image is adjusted according to the preset adjustment strategy for highlighting one or more of the plurality of preset objects, so as to obtain the second object image; and the second object image and the second live streaming picture are fused, so as to obtain the third live streaming picture. In this operation, the first object image of the target object is changed into the second object image by image adjustment and image fusion based on the preset adjustment strategy, and the second object image is fused to the second live streaming picture, so as to obtain the third live streaming picture, so that the third live streaming picture can highlight one or more of the plurality of preset objects. Based on this, by detection, segmentation and adjustment of the target objects in the live streaming picture and re-fusion of the target objects into the live streaming picture, the method can achieve the display effect of highlighting the preset objects in the live streaming picture without changing the size of the live streaming picture, so as to attract viewer users to focus on the preset objects in the live streaming picture, thereby improving the live streaming effect.

In this embodiment of this application, when S203 is performed, based on a principle of highlighting one or more of the plurality of preset objects, adjusting the target object to subsequently highlight the preset objects in the live streaming picture may be adjusting a size of the target object, or adjusting a position of the target object, or adjusting a size and a position of the target object to subsequently highlight the preset objects in the live streaming picture. Therefore, the preset adjustment strategy may be a size adjustment strategy, or a position adjustment strategy, or both a size adjustment strategy and a position adjustment strategy. Therefore, this application provides a possible implementation. The preset adjustment strategy includes one or more of a size adjustment strategy and a position adjustment strategy.

In this embodiment of this application, during a specific implementation of S203, when the preset adjustment strategy is the size adjustment strategy, the size adjustment strategy may be a size upsampling strategy, a size downsampling strategy, a size magnification model, or a size reduction model. Implementations of S203 corresponding to different size adjustment strategies are different, and details are as follows:

An implementation means that the size adjustment strategy is a size upsampling strategy. For the first object image of the target object, a new pixel value may be generated according to an adjacent pixel value in the first object image by the size upsampling strategy, and the new pixel value is inserted into gaps of existing pixel values of the first object image to increase the quantity of pixel values of the first object image, so as to magnify a size of the first object image and improve a resolution of the first object image, thereby obtaining the magnified first object image as the second object image. Therefore, this application provides a possible implementation. When the preset adjustment strategy is the size adjustment strategy, the size adjustment strategy is a size upsampling strategy, and S203 is specifically S2031 (not shown in the figure): perform magnification processing on the first object image according to the size upsampling strategy, so as to obtain the second object image. A size of the second object image is greater than the size of the first object image, and a resolution of the second object image is greater than the resolution of the first object image.

The size upsampling strategy may be a bilinear interpolation algorithm or a bicubic interpolation algorithm. The bilinear interpolation algorithm refers to calculating one new pixel value using 4(2×2) adjacent pixel values in an image. The bicubic interpolation algorithm refers to calculating one new pixel value using 16(4×4) adjacent pixel values in an image.

In S2031, the first object image of the target object is processed by the size upsampling strategy, so that the first object image of the target object is accurately and controllably magnified into the second object image. The second object image is fused to the second live streaming picture to highlight the target object in a plurality of preset objects, thereby providing accurate and effective image data for subsequently highlighting the target object in a plurality of preset objects in the second live streaming picture.

As an example of S2031, based on the foregoing example of S202, the object 2 image 1 indicated in FIG. 6(a) is magnified by the bilinear interpolation algorithm or the bicubic interpolation algorithm, so as to obtain the second object image as an object 2 image 3. A size of the object 2 image 3 is greater than a size of the object 2 image 1, and a resolution of the object 2 image 3 is greater than a resolution of the object 2 image 1.

Another implementation means that the size adjustment strategy is a size downsampling strategy. For the first object image of the target object, a new pixel value may be generated according to an adjacent pixel value in the first object image by the size downsampling strategy, and the adjacent pixel value is replaced with the new pixel value to reduce the quantity of pixel values of the first object image, so as to reduce the size of the first object image and reduce the resolution of the first object image, thereby obtaining the reduced first object image as the second object image. Therefore, this application provides a possible implementation. When the preset adjustment strategy is the size adjustment strategy, the size adjustment strategy is a size downsampling strategy, and S203 is specifically S2032 (not shown in the figure): perform reduction processing on the first object image according to the size downsampling strategy, so as to obtain the second object image. The size of the second object image is less than the size of the first object image, and the resolution of the second object image is less than the resolution of the first object image.

The size downsampling strategy may also be a bilinear interpolation algorithm or a bicubic interpolation algorithm.

In S2032, the first object image of the target object is processed by the size downsampling strategy, so that the first object image of the target object is accurately and controllably reduced to the second object image. The second object image is fused to the second live streaming picture to highlight the objects other than the target object in a plurality of preset objects, thereby providing accurate and effective image data for subsequently highlighting the objects other than the target object in a plurality of preset objects in the second live streaming picture.

As an example of S2032, based on the foregoing example of S203, the object 2 image 1 indicated in FIG. 6(a) is reduced by the bilinear interpolation algorithm or the bicubic interpolation algorithm, so as to obtain the second object image indicated in FIG. 6(b) as an object 2 image 2. A size of the object 2 image 2 is less than the size of the object 2 image 1, and a resolution of the object 2 image 2 is less than the resolution of the object 2 image 1.

Another implementation means that the size adjustment strategy is a size magnification model. A training process of the size magnification model is as follows: a large number of first sample images and second sample images are obtained in advance, where a resolution of the first sample image is less than a resolution of the corresponding second sample image, that is, a size of the first sample image is less than a size of the corresponding second sample image; a first preset model is trained according to a large number of first sample images and second sample images, so as to obtain a size magnification model; and the size magnification model learns a mapping relationship between the first sample image and the second sample image, that is, a mapping relationship between a low-resolution image and a high-resolution image.

Based on this, for the first object image of the target object, the first object image is magnified by the size magnification model, that is, the size of the first object image is magnified according to the mapping relationship between the first sample image and the second sample image, so as to obtain the magnified first object image as the second object image. Therefore, this application provides a possible implementation. When the preset adjustment strategy is the size adjustment strategy, the size adjustment strategy is a size magnification model, and S203 is specifically S2033 (not shown in the figure): perform magnification processing on the first object image according to the size magnification model, so as to obtain the second object image. The size magnification model is configured for magnifying the size of the first object image according to the mapping relationship between the first sample image and the second sample image, and the resolution of the first sample image is less than the resolution of the second sample image. The size of the second object image is greater than the size of the first object image.

The size magnification model may be a super resolution convolutional neural network (SRCNN), and the SRCNN is configured to convert an inputted low-resolution image into a high-resolution image.

In S2033, the first object image of the target object is processed by the size magnification model, so that the first object image of the target object is accurately and intelligently magnified into the second object image. The second object image is fused to the second live streaming picture to highlight the target object in a plurality of preset objects, thereby providing accurate and effective image data for subsequently highlighting the target object in a plurality of preset objects in the second live streaming picture.

As an example of S2033, based on the foregoing example of S202, the object 2 image 1 indicated in FIG. 6(a) is magnified by the SRCNN to obtain the second object image as an object 2 image 4. A size of the object 2 image 4 is greater than the size of the object 2 image 1, and a resolution of the object 2 image 4 is greater than the resolution of the object 2 image 1.

Another implementation means that the size adjustment strategy is a size reduction model. A training process of the size reduction model is as follows: a large number of third sample images and fourth sample images are obtained in advance, where a resolution of the third sample image is greater than a resolution of the corresponding fourth sample image, that is, a size of the third sample image is greater than a size of the corresponding fourth sample image; a second preset model is trained according to a large number of third sample images and fourth sample images, so as to obtain a size reduction model; and the size reduction model learns a mapping relationship between the third sample image and the fourth sample image, that is, a mapping relationship between a high-resolution image and a low-resolution image. Based on this, for the first object image of the target object, the first object image is reduced by the size reduction model, that is, the size of the first object image is reduced according to the mapping relationship between the third sample image and the fourth sample image, so as to obtain the reduced first object image as the second object image. Therefore, this application provides a possible implementation. When the preset adjustment strategy is the size adjustment strategy, the size adjustment strategy is a size reduction model, and S203 is specifically S2034 (not shown in the figure): perform reduction processing on the first object image according to the size reduction model, so as to obtain the second object image. The size reduction model is configured for reducing the size of the first object image according to the mapping relationship between the third sample image and the fourth sample image, and the resolution of the third sample image is greater than the resolution of the fourth sample image. The size of the second object image is less than the size of the first object image.

The size reduction model may be an enhanced super-resolution generative adversarial network (ESRGAN), and the ESRGAN is configured to convert an inputted high-resolution image into a low-resolution image.

In S2034, the first object image of the target object is processed by the size reduction model, so that the first object image of the target object is accurately and intelligently reduced into the second object image. The second object image is fused to the second live streaming picture to highlight the objects other than the target object in a plurality of preset objects, thereby providing accurate and effective image data for subsequently highlighting the objects other than the target object in a plurality of preset objects in the second live streaming picture.

As an example of S2034, based on the foregoing example of S203, the object 2 image 1 indicated in FIG. 6(a) is reduced by the ESRGAN to obtain the second object image indicated in FIG. 6(b) as an object 2 image 2. The size of the object 2 image 2 is less than the size of the object 2 image 1, and the resolution of the object 2 image 2 is less than the resolution of the object 2 image 1.

In this embodiment of this application, during a specific implementation of S203, when the preset adjustment strategy is a position adjustment strategy, for the first object image of the target object, the first object image is moved by the position adjustment strategy, so as to obtain the second object image with a position is different from a position of the first object image. Therefore, this application provides a possible implementation. When the preset adjustment strategy is the position adjustment strategy, S203 is specifically S2035 (not shown in the figure): move the position of the first object image according to the position adjustment strategy, so as to obtain the second object image. A position of the second object image is different from the position of the first object image.

In S2035, the first object image of the target object is processed by the position adjustment strategy, so that the first object image of the target object is accurately moved to the second object image. The second object image is fused to the second live streaming picture to highlight the target object in a plurality of preset objects or the objects other than the target object in a plurality of preset objects, thereby providing accurate and effective image data for subsequently highlighting the preset objects in the second live streaming picture.

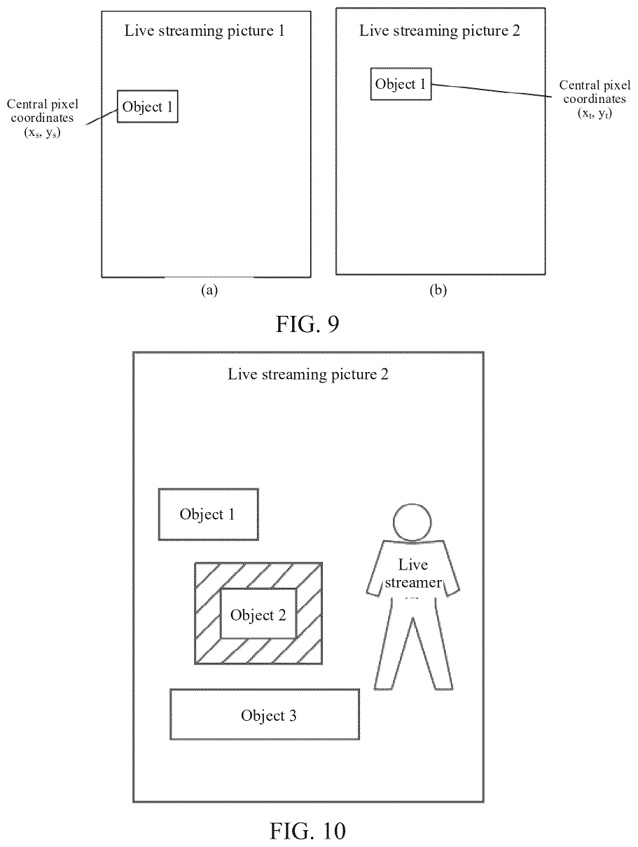

Position movement may be movement of central pixel coordinates. As an example of S2035, based on the foregoing example of S201, in response to a selection operation on the object 1 detection box in a live streamer detection box, an object 1 detection box, an object 2 detection box, and an object 3 detection box in the live streaming picture 1 shown in FIG. 4(a), the terminal determines a target detection box in the live streamer detection box, the object 1 detection box, the object 2 detection box, and the object 3 detection box as the object 1 detection box, and segments an object 1 in the object 1 detection box from the live streaming picture 1, so as to obtain a first object image of the target object as an object 1 image 1 of the object 1. Referring to FIG. 9, FIG. 9 is a schematic diagram of moving a first object image of a target object in a first live streaming picture to a second object image according to an embodiment of this application. The object 1 image 1 indicated in FIG. 9(a) is moved by the position adjustment strategy to obtain the second object image as an object 1 image 2. The position of the object 1 image 2, that is, central pixel coordinates (xt, yt), is different from the position of the object 1 image 1, that is, central pixel coordinates (xs, ys).

Based on the foregoing description, S202 to S203 may determine a target detection box corresponding to the target object in a plurality of candidate detection boxes according to a target object in the live streaming voice corresponding to the first live streaming picture; segment a target object in the target detection box from the first live streaming picture according to the target detection box by an image segmentation algorithm, so as to obtain a second live streaming picture and a first object image of the target object; perform magnification processing on the first object image according to the size upsampling strategy, so as to obtain the second object image; or perform magnification processing on the first object image according to the size magnification model, so as to obtain the second object image; or move the position of the first object image according to the position adjustment strategy, so as to obtain the second object image.

In this mode, whether the live streaming voice corresponding to the first live streaming picture includes the target object in a plurality of preset objects can be automatically detected. If the live streaming voice corresponding to the first live streaming picture includes the target object in a plurality of preset objects, the first live streaming picture can be accurately segmented into a first object image of a to-be-adjusted target object and a to-be-fused second live streaming picture by processing the first live streaming picture by image segmentation. The first object image of the target object is processed by the size upsampling strategy, so that the first object image of the target object is accurately and controllably magnified into the second object image; or the first object image of the target object is processed by the size magnification model, so that the first object image of the target object is accurately and intelligently magnified into the second object image; or the first object image of the target object is processed by the position adjustment strategy, so that the first object image of the target object is accurately moved to the second object image. The second object image is fused to the second live streaming picture to highlight the target object in a plurality of preset objects, thereby subsequently highlighting the target object in a plurality of preset objects in the second live streaming picture.

That is, in this mode, for a plurality of preset objects in a live streaming picture, a target object in a plurality of preset objects described by the live streaming voice corresponding to the live streaming picture can be automatically detected, so as to automatically enlarge the target object in the live streaming picture or adjust the position of the target object in the live streaming picture, thereby highlighting the target object in the live streaming picture. In a product live streaming scenario, the target object may be a target product introduced in the live streaming voice corresponding to a product live streaming picture.

As an example of S202 to S203, based on FIG. 3, in response to detecting that the live streaming voice corresponding to the live streaming picture 1 includes the target object as the object 2, the terminal determines the target detection box as the object 2 detection box, that is, the bold box in FIG. 4(b), in the live streamer detection box, the object 1 detection box, the object 2 detection box, and the object 3 detection box. Based on FIG. 4, the terminal segments the object 2 in the object 2 detection box from the live streaming picture 1, so as to obtain the second live streaming picture indicated in FIG. 5(a) as the live streaming picture 2 and the first object image of the target object indicated in FIG. 5(b) as the object 2 image 1 of the object 2. Based on FIG. 5, the object 2 image 1 indicated in FIG. 6(a) is magnified by the bilinear interpolation algorithm or the bicubic interpolation algorithm, so as to obtain the second object image as an object 2 image 3; or the object 2 image 1 indicated in FIG. 6(a) is magnified by the SRCNN, so as to obtain the second object image as an object 2 image 4; or the object 2 image 1 indicated in FIG. 6(a) is moved by the position adjustment strategy, so as to obtain the second object image as an object 2 image 5, and the object 2 image 5 may be located at a central position of the live streaming picture 2. In a product live streaming scenario, the object 2 is a target product introduced in the live streaming voice corresponding to the live streaming picture 1.

In this embodiment of this application, during a specific implementation of S203, when the preset adjustment strategy includes the size adjustment strategy and the position adjustment strategy, for the first object image of the target object, the first object image is scaled by the size adjustment strategy, so as to obtain an intermediate object image with a size is different from the size of the first object image; and the intermediate object image is moved by the position adjustment strategy, so as to obtain the second object image with a position is different from a position of the intermediate object image. Therefore, this application provides a possible implementation. When the preset adjustment strategy is the position adjustment strategy, S203 includes the following S2036 to S2037 (not shown in the figure):
S2036: Perform size scaling on the first object image according to the size adjustment strategy, so as to obtain the intermediate object image. The size of the intermediate object image is different from the size of the first object image.
S2037: Move the position of the intermediate object image according to the position adjustment strategy, so as to obtain the second object image. The position of the second object image is different from the position of the intermediate object image.

For examples of S2036 to S2037, refer to the foregoing example, and details are not described herein again.

In this embodiment of this application, during a specific implementation of S204, the second live streaming picture refers to the first live streaming picture from which the first object image of the target object is segmented, that is, the second live streaming picture refers to another live streaming picture excluding the first object image of the target object in the first live streaming picture, and the second object image is the adjusted first object image. Therefore, the first object image is adjusted to the second object image. For example, the first object image is reduced or zoomed to the second object image, or the first object image is moved to the second object image. The to-be-filled region that does not match surrounding pixels appears in the second live streaming picture, and the to-be-filled region further needs to be filled with content matching the surrounding pixels, so as to subsequently fuse the second object image and the filled second live streaming picture to obtain a third live streaming picture.

Based on this, when it is determined that the second live streaming picture includes the to-be-filled region by the second object image and the second live streaming picture, first, a similar region around the to-be-filled region in the second live streaming picture needs to be determined as a reference filling region; then, the to-be-filled region in the second live streaming picture is filled according to the region content of the reference filling region, so as to obtain the filled second live streaming picture as a fourth live streaming picture; and finally, the second object image and the fourth live streaming picture are fused to obtain a third live streaming picture. Therefore, this application provides a possible implementation. S204 includes the following S2041 to S2043 (not shown in the figure):
S2041: Determine a similar region around the to-be-filled region in the second live streaming picture as a reference filling region if it is determined that the second live streaming picture includes a to-be-filled region according to the second object image and the second live streaming picture.
S2042: Perform content filling on the to-be-filled region in the second live streaming picture according to region content of the reference filling region, so as to obtain a fourth live streaming picture.

During an actual application, filling the to-be-filled region in the second live streaming picture according to the region content of the reference filling region, so as to obtain the filled second live streaming picture as the fourth live streaming picture means: filling the to-be-filled region in the second live streaming picture with features such as textures, colors, and shapes of the region content of the reference filling region, so as to obtain the filled second live streaming picture as the fourth live streaming picture.
S2043: Perform image fusion on the second object image and the fourth live streaming picture, so as to obtain a third live streaming picture.

In S2041 to S2043, when the second live streaming picture includes the to-be-filled region, the to-be-filled region is filled with the region content of the similar region around the to-be-filled region, so as to obtain the fourth live streaming picture in which the to-be-filled region does not exist. In this way, the second object image is fused to obtain the third live streaming picture, so that a to-be-filled region that do not match surrounding pixels in the third live streaming picture can be avoided, and the display effect of the third live streaming picture can be improved.

As an example of S2041 to S2043, referring to FIG. 10, FIG. 10 is a schematic diagram of a second live streaming picture including a to-be-filled region according to an embodiment of this application. Based on the foregoing adjustment of the object 2 image 1 indicated in FIG. 6(a) to obtain the object 2 image 2 indicated in FIG. 6(b), the second live streaming picture includes a to-be-filled region, that is, an oblique line pattern region is filled in FIG. 10. A similar region around the to-be-filled region in the live streaming picture 2 is determined as a reference filling region; the to-be-filled region in the live streaming picture 2 is filled according to the region content of the reference filling region, so as to obtain the filled live streaming picture 2 as the fourth live streaming picture, that is, a live streaming picture 4; and the object image 2 and the live streaming picture 4 are fused to obtain a live streaming picture 3.

In addition, in this embodiment of this application, based on S2041 to S2042, in the fourth live streaming picture obtained from the second live streaming picture, the filled to-be-filled region and surrounding pixels have a problem of unnatural transition. To solve the problem, the filled to-be-filled region in the fourth live streaming picture further needs to be smoothed based on the second live streaming picture, so as to obtain a smoothed fourth live streaming picture as a fifth live streaming picture. Correspondingly, during a specific implementation of S2043, the second object image and the fifth live streaming picture need to be fused to obtain a third live streaming picture. Therefore, this application provides a possible implementation, and S2043 is specifically S1 and S2044 (not shown in the figure): S1: smooth the filled to-be-filled region in the fourth live streaming picture according to the second live streaming picture, so as to obtain a fifth live streaming picture; and S2044: perform image fusion on the second object image and the fifth live streaming picture, so as to obtain the third live streaming picture.

S1 may smooth the filled to-be-filled region in the fourth live streaming picture according to the second live streaming picture by a Poisson fusion algorithm, so as to obtain a fifth live streaming picture. The Poisson fusion algorithm is configured for smoothing the source image in the fused image according to a gradient field of the source image and a gradient field of the target image when a source image is fused to a target image.

In S1 and S2044, the fifth live streaming picture is obtained by smoothing the filled to-be-filled region in the fourth live streaming picture, so that the transition between the filled to-be-filled region in the fifth live streaming picture and surrounding pixels is more natural. In this way, the second object image is fused to obtain a third live streaming picture, so as to avoid unnatural pixel transition in the third live streaming picture, thereby further improving the display effect of the third live streaming picture.

As an example of S1 and S2044, based on the live streaming picture 4 obtained by the foregoing example of S2041 to S2043, the filled to-be-filled region in the live streaming picture 4 is smoothed based on the live streaming picture 2, so as to obtain a smoothed live streaming picture 4 as a fifth live streaming picture, that is, a live streaming picture 5. Correspondingly, the object image 2 and the live streaming picture 5 are fused to obtain a live streaming picture 3.

In addition, in this embodiment of this application, based on S204, in the third live streaming picture obtained by fusing the second object image with the second live streaming picture, the second object image and the second live streaming picture have a problem of unnatural transition. To solve the problem, the second object image in the third live streaming picture further needs to be smoothed based on the second live streaming picture in the third live streaming picture, so as to obtain a smoothed third live streaming picture as a sixth live streaming picture. Therefore, this application provides a possible implementation. The method further includes S2 (not shown in the figure): smooth the second object image in the third live streaming picture according to the second live streaming picture in the third live streaming picture, so as to obtain a sixth live streaming picture.

In S2, by smoothing the second object image in the third live streaming picture, the transition between the second object image in the sixth live streaming picture and the second live streaming picture is more natural, and the third live streaming picture is replaced with the sixth live streaming picture to achieve the display effect of highlighting the preset objects in the live streaming picture, so as to attract viewer users to focus on the preset objects in the live streaming picture, thereby improving the display effect of the sixth live streaming picture to further improve the live streaming effect.

As an example of S2, based on the foregoing example of S204, the object 2 image 2 in the live streaming picture 3 is smoothed based on the live streaming picture 2 in the live streaming picture 3, so as to obtain a smoothed live streaming picture 3 as a sixth live streaming picture, that is, a live streaming picture 6.

At least the following two implementations may be used for S2:

An implementation is as follows: the second object image in the third live streaming picture is smoothed according to the second live streaming picture in the third live streaming picture by a Poisson fusion algorithm, so as to obtain a sixth live streaming picture. The Poisson fusion algorithm is configured for smoothing the source image in the fused image according to a gradient field of the source image and a gradient field of the target image when a source image is fused to a target image. Therefore, the second object image is used as the source image, and the second live streaming picture is used as the target image. First, a first gradient field of the second object image in the third live streaming picture, and a second gradient field of the second live streaming picture in the third live streaming picture need to be obtained. Then, the second object image in the third live streaming picture is smoothed based on the first gradient field and the second gradient field, so as to obtain a smoothed third live streaming picture as a sixth live streaming picture. That is, this application provides a possible implementation. S2 includes the following S21 to S22 (not shown in the figure):
S21: Obtain a first gradient field of the second object image in the third live streaming picture and a second gradient field of the second live streaming picture in the third live streaming picture.
S22: Smooth the second object image in the third live streaming picture according to the first gradient field and the second gradient field, so as to obtain a sixth live streaming picture.

As an example of S21 to S22, based on the foregoing example of S2, the first gradient field of the object 2 image 2 in the live streaming picture 3 is obtained as a gradient field 1, the second gradient field of the live streaming picture 2 in the live streaming picture 3 is obtained as a gradient field 2, and the object 2 image 2 in the live streaming picture 3 is smoothed based on the gradient field 1 and the gradient field 2, so as to obtain a smoothed live streaming picture 3 as a sixth live streaming picture, that is, a live streaming picture 6.

Another implementation is as follows: a large number of source images and target images are obtained in advance, the source images being to be fused to the target images; a third preset model is trained according to a large number of source images and target images to obtain an image smoothing model; and the image smoothing model learns a mapping relationship between the source image and the target image. Based on this, the second object image is used as the source image, the second live streaming picture is used as the target image, and the second object image in the third live streaming picture is smoothed by the image smoothing model according to the mapping relationship between the second object image and the second live streaming picture, so as to obtain a smoothed third live streaming picture as a sixth live streaming picture. Therefore, this application provides a possible implementation, and S2 is specifically S23 (not shown in the figure): smooth the second object image in the third live streaming picture by an image smoothing model according to a mapping relationship between the second object image and the second live streaming picture, so as to obtain a sixth live streaming picture.

As an example of S23, based on the foregoing example of S2, the object 2 image 2 in the live streaming picture 3 is smoothed by the image smoothing model according to the mapping relationship between the object 2 image 2 in the live streaming picture 3 and the live streaming picture 2 in the live streaming picture 3, so as to obtain a smoothed live streaming picture 3 as a sixth live streaming picture, that is, a live streaming picture 6.

In this embodiment of this application, if the foregoing adjustment method based on a live streaming picture is performed in real time, many calculation operations need to be performed, and many calculation resources are consumed. To save calculation resources, a certain detection frequency may be set, and object detection is performed for the picture content of the first live streaming picture according to the set detection frequency, so as to obtain candidate detection boxes respectively corresponding to a plurality of preset objects in the first live streaming picture. Therefore, this application provides a possible implementation, and S201 is specifically S2011 (not shown in the figure): perform object detection on the picture content of the first live streaming picture according to a detection frequency, so as to obtain the candidate detection boxes respectively corresponding to the plurality of preset objects in the first live streaming picture.

In S2011, the first live streaming picture is processed by object detection according to the detection frequency, so that candidate detection boxes of each preset object in the first live streaming picture can be intermittently and accurately detected, thereby providing effective and accurate detection data for subsequently accurately segmenting the first live streaming picture into a first object image of a to-be-adjusted target object and a to-be-fused second live streaming picture while saving calculation resources.

As an example of S2011, the detection frequency is tar_freq. Based on the foregoing example of S201, object detection is performed for the picture content of the live streaming picture 1 according to tar_freq, so as to obtain a live streamer detection box, an object 1 detection box, an object 2 detection box, and an object 3 detection box in the live streaming picture 1.

The detection frequency may be dynamically updated based on whether the preset objects in two previous and following frames of first live streaming picture move. During an actual application, any preset object in the plurality of preset objects is used as a first object, where i is a positive integer. When a first object in an (i+1)^{th} frame of first live streaming picture moves relative to a first object in an i^{th} frame of first live streaming picture, extremely frequent object detection needs to be performed to obtain a plurality of candidate detection boxes corresponding to a plurality of preset objects in the first live streaming picture, and a maximum frequency is used as a detection frequency. When a plurality of preset objects in the (i+1)^{th} frame of first live streaming picture do not move relative to a plurality of preset objects in the i^{th} frame of first live streaming picture, the detection frequency may be reduced. Object detection does not need to be frequently performed to obtain a plurality of candidate detection boxes corresponding to a plurality of preset objects in the first live streaming picture. Therefore, a difference frequency between the detection frequency and a preset frequency is used as a detection frequency. When the detection frequency is a minimum frequency, the detection frequency does not need to be reduced. Therefore, this application provides a possible implementation, and an operation of obtaining the detection frequency includes S3 or S4 as follows:
S3: Update the detection frequency according to a maximum frequency if a first object in an (i+1)^{th} frame of first live streaming picture moves relative to a first object in an i^{th} frame of first live streaming picture, i being a positive integer.

S4: Update the detection frequency according to a difference frequency between the detection frequency and a preset frequency if a plurality of preset objects in the (i+1)^{th} frame of first live streaming picture do not move relative to a plurality of preset objects in the i^{th} frame of first live streaming picture, the updated detection frequency being greater than or equal to a minimum frequency.

In S3 and S4, the detection frequency is dynamically updated based on whether the preset objects in two previous and following frames of first live streaming picture move. Based on saving calculation resources, when the preset objects in two previous and following frames of first live streaming picture move, extremely frequent object detection is performed at a maximum detection frequency, so as to obtain a plurality of candidate detection boxes corresponding to a plurality of preset objects in the first live streaming picture. When the preset objects in two previous and following frames of first live streaming picture do not move, the detection frequency of a plurality of candidate detection boxes corresponding to a plurality of preset objects in the first live streaming picture is reduced.

As an example of S3 and S4, based on the foregoing example of S201, referring to FIG. 11, FIG. 11 is a flowchart of determining a detection frequency according to an embodiment of this application. The process includes: obtain a detection frequency; determine whether a first object in an (i+1)^{th} frame of first live streaming picture moves relative to a first object in an i^{th} frame of first live streaming picture; if yes, update the detection frequency according to a maximum frequency; and if not, that is, a plurality of preset objects in the (i+1)^{th} frame of first live streaming picture do not move relative to a plurality of preset objects in the i^{th} frame of first live streaming picture, update the detection frequency according to a difference frequency between the detection frequency and a preset frequency. The updated detection frequency is greater than or equal to a minimum frequency.

An implementation of determining that the first object in the (i+1)^{th} frame of first live streaming picture moves relative to the first object in the i^{th} frame of first live streaming picture is: determining that positions of some pixels in a plurality of pixels of the first object in the (i+1)^{th} frame of first live streaming picture relative to a plurality of pixels of the first object in the i^{th} frame of first live streaming picture change. Based on this, first, a plurality of coordinate differences between a plurality of pixel coordinates of the first object in the (i+1)^{th} frame of first live streaming picture and a plurality of pixel coordinates of the first object in the i^{th} frame of first live streaming picture are obtained; then, whether a preset quantity of coordinate differences in the plurality of coordinate differences is greater than a preset difference is determined; if yes, it can be determined that the first object in the (i+1)^{th} frame of first live streaming picture moves relative to the first object in the i^{th} frame of first live streaming picture; and if not, it can be determined that the first object in the (i+1)^{th} frame of first live streaming picture does not move relative to the first object in the i^{th} frame of first live streaming picture, where the preset quantity is configured according to actual needs. Therefore, this application provides a possible implementation. The operation of determining movement of the first object in the (i+1)^{th} frame of first live streaming picture relative to the first object in the i^{th} frame of first live streaming picture includes the following S5 to S6:
S5: Obtain a plurality of coordinate differences between a plurality of pixel coordinates of the first object in the (i+1)^{th} frame of first live streaming picture and a plurality of pixel coordinates of the first object in the i^{th} frame of first live streaming picture.
S6: Determine that the first object in the (i+1)^{th} frame of first live streaming picture moves relative to the first object in the i^{th} frame of first live streaming picture if a preset quantity of coordinate differences in the plurality of coordinate differences are greater than a preset difference.

In S5 to S6, positions of some pixels of the first object in the (i+1)^{th} frame of first live streaming picture are changed relative to positions of some pixels corresponding to the first object in the i^{th} frame of first live streaming picture, and it is determined that the first object in the (i+1)^{th} frame of first live streaming picture moves relative to the first object in the i^{th} frame of first live streaming picture, so that whether the preset objects in two previous and following frames of first live streaming picture move can be accurately determined, thereby providing an accurate update basis for subsequently dynamically updating the detection frequency.

As an example of S5 to S6, the preset difference is Diff_Threshold, and N coordinate differences between N pixel coordinates of the first object in the (i+1)^{th} frame of first live streaming picture and N pixel coordinates of the first object in the i^{th} frame of first live streaming picture are obtained. The coordinate difference refers to a spatial distance between the pixel coordinates of the first object in the (i+1)^{th} frame of first live streaming picture and the pixel coordinates of the first object in the i^{th} frame of first live streaming picture. Whether N/16 coordinate differences in the N coordinate differences are greater than Diff_Threshold is determined, where N is a positive integer, and N is a multiple of 16, and if yes, it can be determined that the first object in the (i+1)^{th} frame of first live streaming picture moves relative to the first object in the i^{th} frame of first live streaming picture. Diff_Threshold may be 1/100 of the width of the first live streaming picture.

In addition, in this embodiment of this application, when S203 is performed, the target object is adjusted based on a principle of highlighting one or more of the plurality of preset objects, so that the preset objects may be highlighted in the live streaming picture subsequently, or the preset objects may be highlighted in the live streaming picture by replacing the target object. The preset adjustment strategy may also be a replacement adjustment strategy. For the first object image of the target object, the first object image is replaced with a preset replacement image different from the first object image by the replacement adjustment strategy, and the preset replacement image is used as a second object image. Therefore, this application provides a possible implementation. The preset adjustment strategy further includes a replacement adjustment strategy. S203 is specifically S2038 (not shown in the figure): perform replacement processing on the first object image according to the preset replacement image by the replacement adjustment strategy, so as to obtain a second object image.

In S2038, the first object image of the target object is processed by the replacement adjustment strategy, so that the first object image of the target object is replaced with the preset replacement image as the second object image. The second object image is fused to the second live streaming picture to highlight the objects other than the target object in a plurality of preset objects, thereby providing accurate and effective image data for subsequently highlighting the objects other than the target object in a plurality of preset objects in the second live streaming picture.

As an example of S2038, based on the foregoing example of S203, the object 2 image 1 indicated in FIG. 6(a) is replaced with the preset replacement image by the replacement adjustment strategy, so as to obtain a second object image as a preset replacement image.

In addition, in this embodiment of this application, after the first live streaming picture is segmented into the second live streaming picture and the first object image of the target object in S202, the first object image may further be deleted, and the second live streaming picture is filled with content, so as to obtain a seventh live streaming picture. In this way, the objects other than the target object in a plurality of preset objects are highlighted in the seventh live streaming picture to achieve the display effect of highlighting the preset objects in the live streaming picture, so as to attract viewer users to focus on the preset objects in the live streaming picture, thereby improving the live streaming effect.

Based on the implementations provided in the foregoing aspects, this application may be further combined to provide more implementations.

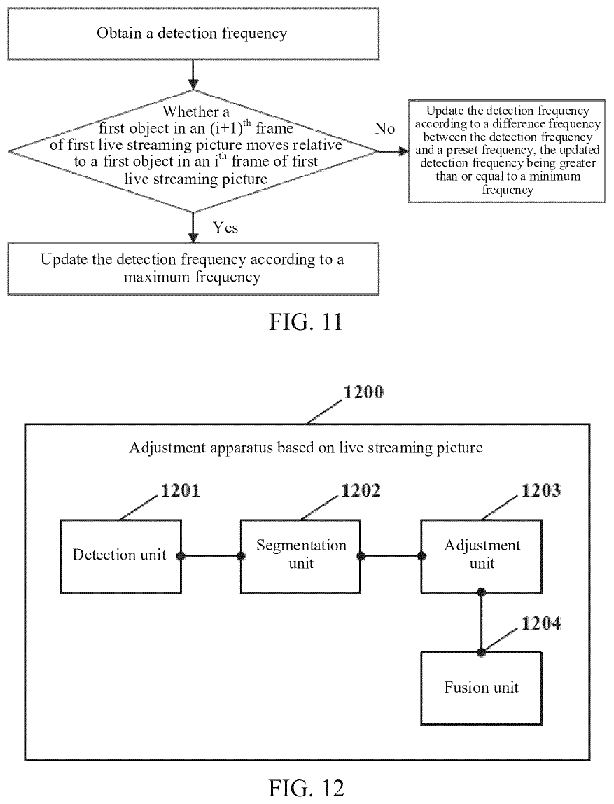

Based on the adjustment method based on a live streaming picture according to the embodiment corresponding to FIG. 2, an embodiment of this application further provides an adjustment apparatus based on a live streaming picture. Referring to FIG. 12, FIG. 12 is a structural diagram of an adjustment apparatus based on a live streaming picture according to an embodiment of this application. The adjustment apparatus 1200 based on a live streaming picture includes: a detection unit 1201, a segmentation unit 1202, an adjustment unit 1203, and a fusion unit 1204, where
the detection unit 1201 is configured to perform object detection on picture content of a first live streaming picture, so as to obtain candidate detection boxes respectively corresponding to a plurality of preset objects in the first live streaming picture;
the segmentation unit 1202 is configured to segment a target object in a target detection box from the first live streaming picture according to the target detection box in the plurality of candidate detection boxes, so as to obtain a second live streaming picture and a first object image of the target object, the second live streaming picture referring to a live streaming picture excluding the first object image of the target object in the first live streaming picture;
the adjustment unit 1203 is configured to adjust the first object image according to a preset adjustment strategy, so as to obtain a second object image, the preset adjustment strategy being configured for highlighting one or more of the plurality of preset objects; and
the fusion unit 1204 is configured to perform image fusion on the second object image and the second live streaming picture, so as to obtain a third live streaming picture.

In a possible implementation, the preset adjustment strategy includes one or more of a size adjustment strategy and a position adjustment strategy.

In a possible implementation, when the preset adjustment strategy is a size adjustment strategy, the size adjustment strategy is a size upsampling strategy, and the adjustment unit 1203 is specifically configured to:
perform magnification processing on the first object image according to the size upsampling strategy, so as to obtain the second object image; or
the size adjustment strategy is a size downsampling strategy, and the adjustment unit 1203 is specifically configured to:
perform reduction processing on the first object image according to the size downsampling strategy, so as to obtain the second object image.

In a possible implementation, when the preset adjustment strategy is a size adjustment strategy, the size adjustment strategy is a size magnification model, and the adjustment unit 1203 is specifically configured to:
perform magnification processing on the first object image according to the size magnification model, so as to obtain the second object image, the size magnification model being configured for magnifying a size of the first object image according to a mapping relationship between a first sample image and a second sample image, and a resolution of the first sample image being less than a resolution of the second sample image; or
the size adjustment strategy is a size reduction model, and the adjustment unit 1203 is specifically configured to:
perform reduction processing on the first object image according to the size reduction model, so as to obtain the second object image, the size reduction model being configured for reducing the size of the first object image according to a mapping relationship between a third sample image and a fourth sample image, and a resolution of the third sample image being greater than a resolution of the fourth sample image.

In a possible implementation, when the preset adjustment strategy is a position adjustment strategy, the adjustment unit 1203 is specifically configured to:
move a position of the first object image according to the position adjustment strategy, so as to obtain the second object image, a position of the second object image being different from the position of the first object image.

In a possible implementation, the fusion unit 1204 is specifically configured to:
determine a similar region around the to-be-filled region in the second live streaming picture as a reference filling region if it is determined that the second live streaming picture includes a to-be-filled region according to the second object image and the second live streaming picture;
perform content filling on the to-be-filled region in the second live streaming picture according to region content of the reference filling region, so as to obtain a fourth live streaming picture; and
perform image fusion on the second object image and the fourth live streaming picture, so as to obtain a third live streaming picture.

In a possible implementation, the apparatus further includes: a smoothing unit, where
the smoothing unit is configured to smooth the filled to-be-filled region in the fourth live streaming picture according to the second live streaming picture, so as to obtain a fifth live streaming picture; and
the fusion unit 1204 is specifically configured to:
perform image fusion on the second object image and the fifth live streaming picture, so as to obtain the third live streaming picture.

In a possible implementation, the smoothing unit is further configured to:
smooth the second object image in the third live streaming picture according to the second live streaming picture in the third live streaming picture, so as to obtain a sixth live streaming picture.

In a possible implementation, the smoothing unit is specifically configured to:
obtain a first gradient field of the second object image in the third live streaming picture and a second gradient field of the second live streaming picture in the third live streaming picture; and
smooth the second object image in the third live streaming picture according to the first gradient field and the second gradient field, so as to obtain a sixth live streaming picture.

In a possible implementation, the smoothing unit is specifically configured to:
smooth the second object image in the third live streaming picture by an image smoothing model according to a mapping relationship between the second object image and the second live streaming picture, so as to obtain the sixth live streaming picture.

In a possible implementation, the detection unit 1201 is specifically configured to:
perform object detection on the picture content of the first live streaming picture according to a detection frequency, so as to obtain the candidate detection boxes respectively corresponding to the plurality of preset objects in the first live streaming picture.

In a possible implementation, the apparatus further includes: an update unit, where
the update unit is specifically configured to:
update the detection frequency according to a maximum frequency if a first object in an (i+1)^{th} frame of first live streaming picture moves relative to a first object in an i^{th} frame of first live streaming picture, the first object being any preset object in the plurality of preset objects, and i being a positive integer; and
update the detection frequency according to a difference frequency between the detection frequency and a preset frequency if a plurality of preset objects in the (i+1)^{th} frame of first live streaming picture do not move relative to a plurality of preset objects in the i^{th} frame of first live streaming picture, the updated detection frequency being greater than or equal to a minimum frequency.

In a possible implementation, the apparatus further includes: a determining unit, where
the determining unit is specifically configured to:
obtain a plurality of coordinate differences between a plurality of pixel coordinates of the first object in the (i+1)^{th} frame of first live streaming picture and a plurality of pixel coordinates of the first object in the i^{th} frame of first live streaming picture; and
determine that the first object in the (i+1)^{th} frame of first live streaming picture moves relative to the first object in the i^{th} frame of first live streaming picture if a preset quantity of coordinate differences in the plurality of coordinate differences are greater than a preset difference.

In a possible implementation, the preset adjustment strategy further includes a replacement adjustment strategy; and the adjustment unit 1203 is specifically configured to:
perform replacement processing on the first object image according to a preset replacement image based on the replacement adjustment strategy, so as to obtain the second object image.

It can be seen from the foregoing technical solution that object detection is performed on the picture content of the first live streaming picture, so as to obtain the plurality of candidate detection boxes corresponding to the plurality of preset objects in the first live streaming picture; and the target object in the target detection box is segmented from the first live streaming picture for the target detection box in the plurality of candidate detection boxes, so as to obtain the second live streaming picture and the first object image of the target object. By the detection unit and the segmentation unit, the first live streaming picture can be accurately segmented into the first object image of the to-be-adjusted target object and the to-be-fused second live streaming picture. The first object image is adjusted according to a preset adjustment strategy for highlighting one or more of the plurality of preset objects, so as to obtain a second object image; and the second object image and the second live streaming picture are fused, so as to obtain a third live streaming picture. The first object image of the target object is changed into the second object image by the adjustment unit and the fusion unit based on the preset adjustment strategy, and the second object image is fused to the second live streaming picture, so as to obtain the third live streaming picture, so that the third live streaming picture can highlight one or more of the plurality of preset objects. Based on this, by detection, segmentation and adjustment of the target objects in the live streaming picture and re-fusion of the target objects into the live streaming picture, the method can achieve the display effect of highlighting the preset objects in the live streaming picture without changing the size of the live streaming picture, so as to attract viewer users to focus on the preset objects in the live streaming picture, thereby improving the live streaming effect.

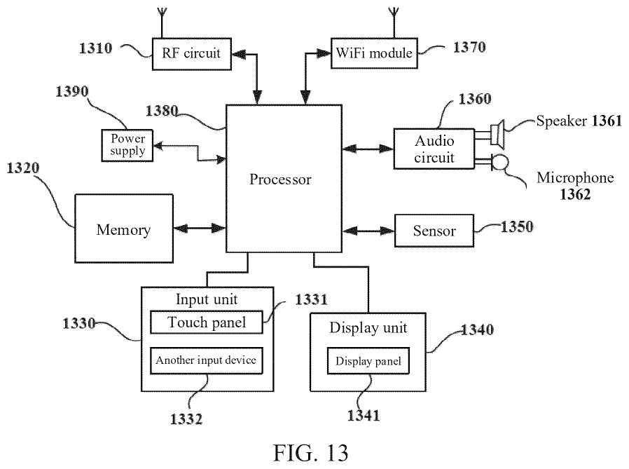

An embodiment of this application further provides a computer device. The computer device may be a terminal. Referring to FIG. 13, FIG. 13 is a structural diagram of a terminal according to an embodiment of this application. For example, the terminal is a smartphone, and the smartphone includes: components such as a radio frequency (RF) circuit 1310, a memory 1320, an input unit 1330, a display unit 1340, a sensor 1350, an audio circuit 1360, a wireless fidelity (Wi-Fi) module 1370, a processor 1380, and a power supply 13120. The input unit 1330 may include a touch panel 1331 and another input device 1332. The display unit 1340 may include a display panel 1341. The audio circuit 1360 may include a speaker 1361 and a microphone 1362. Those skilled in the art may understand that the structure of the smartphone shown in FIG. 13 does not constitute a limitation to the smartphone, and the smartphone may include more components or fewer components than those shown in the figure, or some components may be combined, or a different component deployment may be used.

The memory 1320 may be configured to store a software program and a module. The processor 1380 runs the software program and module stored in the memory 1320 to implement various functional applications and data processing of the smartphone. The memory 1320 may mainly include a program storage region and a data storage region, where the program storage region may store an operating system, an application program required by at least one function (such as a sound playback function and an image playback function), and the like; and the data storage region may store data (such as audio data and an address book) created according to use of the smartphone, and the like. In addition, the memory 1320 may include a high-speed random access memory, and may also include a non-volatile memory such as at least one magnetic disk storage device, a flash memory, or another volatile solid-state storage device.

The processor 1380 is a control center of the smartphone, is connected to various parts of the entire smartphone by various interfaces and lines, and executes various functions of the smartphone and processes data by running or executing a software program and/or a module stored in the memory 1320 and invoking data stored in the memory 1320. In some embodiments, the processor 1380 may include one or more processing units. Preferably, the processor 1380 may integrate an application processor and a modem processor, where the application processor mainly processes an operating system, a user interface, an application program, and the like; and the modem processor mainly processes wireless communication. The foregoing modem processor may not be integrated into the processor 1380.

In this embodiment, the processor 1380 in the smartphone may perform the method provided in various exemplary implementations of the foregoing embodiments.

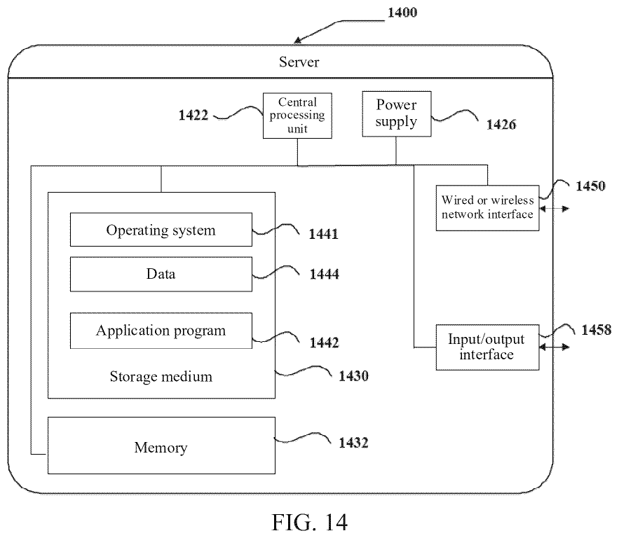

The computer device provided in this embodiment of this application may further be a server. Referring to FIG. 14, FIG. 14 is a structural diagram of a server according to an embodiment of this application. The server 1400 may vary greatly due to different configurations or performance, and may include one or more processors, for example, a central processing unit (CPU) 1422, a memory 1432, and one or more storage media 1430 (for example, one or more mass storage devices) that store application programs 1442 or data 1444. The memory 1432 and the storage medium 1430 may be transient or persistent storages. The program stored in the storage medium 1430 may include one or more modules (not shown in the figure), and each module may include a series of instructions and operations for the server. Still further, the CPU 1422 may be configured to communicate with the storage medium 1430, and perform, on the server 1400, a series of instructions and operations in the storage medium 1430.

The server 1400 may further include one or more power supplies 1426, one or more wired or wireless network interfaces 1450, one or more input/output interfaces 1458, and/or one or more operating systems 1441, for example, Windows Server™, Mac OS X™, Unix™, Linux™, or FreeBSD™.

In this embodiment, the central processing unit 1422 in the server 1400 may perform the method provided in various exemplary implementations of the foregoing embodiments.

According to one aspect of this application, a computer-readable storage medium is provided. The computer-readable storage medium is configured to store a computer program. The computer program, when run on a computer device, causes the computer device to perform the method provided in various exemplary implementations of the foregoing embodiments.

According to one aspect of this application, a computer program product is provided. The computer program product includes a computer program, and the computer program is stored in a computer-readable storage medium. A processor of a computer device reads the computer program from the computer-readable storage medium. The processor executes the computer program to cause the computer device to perform the method provided in various exemplary implementations of the foregoing embodiments.

The descriptions of processes or structures corresponding to the foregoing accompanying drawings have respective focuses. For a part that is not described in detail in a process or structure, refer to related descriptions of other processes or structures.

The terms such as “first” and “second” in the specification and above accompanying drawings of this application are intended to distinguish similar objects, rather than describe a specific sequence or order. The data used in this way may be interchanged under appropriate conditions, so that the embodiments of this application described herein may be implemented in a sequence other than those illustrated or described herein. Moreover, the terms “include” and “have” and any other variants thereof are intended to cover a non-exclusive inclusion. For example, a process, method, system, product, or device that includes a series of operations or units is not necessarily limited to those expressly listed operations or units, but may include other operations or units not expressly listed or inherent to such a process, method, product, or device.

In several embodiments provided in this application, the disclosed system, apparatus, and method may be implemented in other modes. For example, the described apparatus embodiment is merely an example. For example, the unit division is merely logical function division and may be other division during actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electrical, mechanical, or other forms.

The units described as separate parts may or may not be physically separate, and parts displayed as units may or may not be physical units, in other words, may be located at one position, or may be distributed on a plurality of network units. Some or all of the units may be selected according to actual needs to achieve the objectives of the solution of this embodiment.

Moreover, functional units in the embodiments of this application may be integrated into one processing unit, or each of the units may exist alone physically, or two or more units are integrated into one unit. The foregoing integrated unit may be implemented in the form of hardware, or may be implemented in the form of a software functional unit.

When the integrated unit is implemented in the form of a software functional unit and sold or used as an independent product, the integrated unit may be stored in a computer-readable storage medium. Based on such an understanding, the technical solutions of this application essentially, or a part contributing to the related art, or all or a part of the technical solution may be implemented in the form of a software product. The computer software product is stored in a storage medium and includes several instructions for instructing a computer device to perform all or some of operations of the methods in the embodiments of this application. The foregoing storage medium includes any medium that can store a computer program, such as a Universal Serial Bus (USB) flash drive, a removable hard disk, a read-only memory (ROM), a random access memory (RAM), a magnetic disk, a compact disc, or the like.

In conclusion, the foregoing embodiments are merely intended for describing the technical solutions of this application, but not for limiting this application. Although this application is described in detail with reference to the foregoing embodiments, a person of ordinary skilled in the art may understand that modifications may still be made to the technical solutions described in the foregoing embodiments, or equivalent replacements may be made to some technical features, and such modifications or replacements do not cause the essence of the corresponding technical solutions to depart from the spirit and scope of the technical solutions of the embodiments of this application.

What is claimed is:

1. A method for adjusting a live streaming picture performed by a computer device, the method comprising:
performing object detection on picture content of a first live streaming picture to obtain candidate detection boxes respectively corresponding to a plurality of preset objects in the first live streaming picture;
segmenting a target object in a target detection box from the first live streaming picture to obtain a second live streaming picture and a first object image of the target object, the second live streaming picture referring to a live streaming picture excluding the first object image of the target object in the first live streaming picture;
adjusting the first object image according to a preset adjustment strategy to obtain a second object image; and
performing image fusion on the second object image and the second live streaming picture to obtain a third live streaming picture including the second object image.

2. The method according to claim 1, wherein the preset adjustment strategy comprises one or more of a size adjustment strategy and a position adjustment strategy, the preset adjustment strategy being configured for highlighting one or more of the plurality of preset objects.

3. The method according to claim 2, wherein the adjusting the first object image according to a preset adjustment strategy to obtain a second object image comprises:
performing magnification processing on the first object image according to the size upsampling strategy to obtain the second object image.

4. The method according to claim 2, wherein the adjusting the first object image according to a preset adjustment strategy to obtain a second object image comprises:
performing reduction processing on the first object image according to the size downsampling strategy to obtain the second object image.

5. The method according to claim 2, wherein the adjusting the first object image according to a preset adjustment strategy to obtain a second object image comprises:
performing magnification processing on the first object image according to the size magnification model, so as to obtain the second object image, the size magnification model being configured for magnifying a size of the first object image according to a mapping relationship between a first sample image and a second sample image, and a resolution of the first sample image being less than a resolution of the second sample image.

6. The method according to claim 2, wherein the adjusting the first object image according to a preset adjustment strategy to obtain a second object image comprises:
performing reduction processing on the first object image according to the size reduction model, so as to obtain the second object image, the size reduction model being configured for reducing the size of the first object image according to a mapping relationship between a third sample image and a fourth sample image, and a resolution of the third sample image being greater than a resolution of the fourth sample image.

7. The method according to claim 2, wherein the adjusting the first object image according to a preset adjustment strategy to obtain a second object image comprises:
moving a position of the first object image according to the position adjustment strategy to obtain the second object image, a position of the second object image being different from the position of the first object image.

8. The method according to claim 1, wherein the performing image fusion on the second object image and the second live streaming picture to obtain a third live streaming picture including the second object image comprises:
determining a similar region around a to-be-filled region in the second live streaming picture as a reference filling region if it is determined that the second live streaming picture comprises the to-be-filled region according to the second object image and the second live streaming picture;
performing content filling on the to-be-filled region in the second live streaming picture according to region content of the reference filling region, so as to obtain a fourth live streaming picture; and
performing image fusion on the second object image and the fourth live streaming picture, so as to obtain the third live streaming picture.

9. The method according to claim 1, wherein the method further comprises:
smoothing the second object image in the third live streaming picture according to the second live streaming picture in the third live streaming picture, so as to obtain a sixth live streaming picture.

10. The method according to claim 1, wherein the performing object detection on picture content of a first live streaming picture to obtain candidate detection boxes respectively corresponding to a plurality of preset objects in the first live streaming picture comprises:
performing object detection on the picture content of the first live streaming picture according to a detection frequency to obtain the candidate detection boxes respectively corresponding to the plurality of preset objects in the first live streaming picture.

11. The method according to claim 1, wherein the adjusting the first object image according to a preset adjustment strategy to obtain a second object image comprises:
performing replacement processing on the first object image according to a preset replacement image based on the replacement adjustment strategy, so as to obtain the second object image.

12. A computer device, the computer device comprising a processor and a memory,
the memory being configured to store a computer program and transmit the computer program to the processor; and
the processor being configured to perform a method for adjusting a live streaming picture, the method being performed by a computer device, and the method comprising:
performing object detection on picture content of a first live streaming picture to obtain candidate detection boxes respectively corresponding to a plurality of preset objects in the first live streaming picture;
segmenting a target object in a target detection box from the first live streaming picture to obtain a second live streaming picture and a first object image of the target object, the second live streaming picture referring to a live streaming picture excluding the first object image of the target object in the first live streaming picture;
adjusting the first object image according to a preset adjustment strategy to obtain a second object image; and
performing image fusion on the second object image and the second live streaming picture to obtain a third live streaming picture including the second object image.

13. The computer device according to claim 12, wherein the preset adjustment strategy comprises one or more of a size adjustment strategy and a position adjustment strategy, the preset adjustment strategy being configured for highlighting one or more of the plurality of preset objects.

14. The computer device according to claim 12, wherein the performing image fusion on the second object image and the second live streaming picture to obtain a third live streaming picture including the second object image comprises:
determining a similar region around a to-be-filled region in the second live streaming picture as a reference filling region if it is determined that the second live streaming picture comprises the to-be-filled region according to the second object image and the second live streaming picture;
performing content filling on the to-be-filled region in the second live streaming picture according to region content of the reference filling region, so as to obtain a fourth live streaming picture; and
performing image fusion on the second object image and the fourth live streaming picture, so as to obtain the third live streaming picture.

15. The computer device according to claim 12, wherein the method further comprises:
smoothing the second object image in the third live streaming picture according to the second live streaming picture in the third live streaming picture, so as to obtain a sixth live streaming picture.

16. The computer device according to claim 12, wherein the performing object detection on picture content of a first live streaming picture to obtain candidate detection boxes respectively corresponding to a plurality of preset objects in the first live streaming picture comprises:
performing object detection on the picture content of the first live streaming picture according to a detection frequency to obtain the candidate detection boxes respectively corresponding to the plurality of preset objects in the first live streaming picture.

17. The computer device according to claim 12, wherein the adjusting the first object image according to a preset adjustment strategy to obtain a second object image comprises:
performing replacement processing on the first object image according to a preset replacement image based on the replacement adjustment strategy, so as to obtain the second object image.

18. A non-transitory computer-readable storage medium storing a computer program, and the computer program, when executed by a processor of a computer device, causing the computer device to perform a method for adjusting a live streaming picture performed by a computer device, the method comprising:
performing object detection on picture content of a first live streaming picture to obtain candidate detection boxes respectively corresponding to a plurality of preset objects in the first live streaming picture;
segmenting a target object in a target detection box from the first live streaming picture to obtain a second live streaming picture and a first object image of the target object, the second live streaming picture referring to a live streaming picture excluding the first object image of the target object in the first live streaming picture;
adjusting the first object image according to a preset adjustment strategy to obtain a second object image; and
performing image fusion on the second object image and the second live streaming picture to obtain a third live streaming picture including the second object image.

19. The non-transitory computer-readable storage medium according to claim 18, wherein the performing image fusion on the second object image and the second live streaming picture to obtain a third live streaming picture including the second object image comprises:
determining a similar region around a to-be-filled region in the second live streaming picture as a reference filling region if it is determined that the second live streaming picture comprises the to-be-filled region according to the second object image and the second live streaming picture;
performing content filling on the to-be-filled region in the second live streaming picture according to region content of the reference filling region, so as to obtain a fourth live streaming picture; and
performing image fusion on the second object image and the fourth live streaming picture, so as to obtain the third live streaming picture.

20. The non-transitory computer-readable storage medium according to claim 18, wherein the method further comprises:
smoothing the second object image in the third live streaming picture according to the second live streaming picture in the third live streaming picture, so as to obtain a sixth live streaming picture.
